(19) United States
(12) Patent Application Publication
(10) Pub. No.: US 2025/0124617 A1
(43) Pub. Date: Apr. 17, 2025

(54) NUCLEAR MEDICINE DIAGNOSTIC DEVICE AND DATA PROCESSING DEVICE

(71) Applicant: CANON MEDICAL SYSTEMS CORPORATION, Tochigi (JP)

(72) Inventor: Masaki MIYAHARA, Otawara (JP)

(73) Assignee: CANON MEDICAL SYSTEMS CORPORATION, Tochigi (JP)

(21) Appl. No.: 18/913,371

(22) Filed: Oct. 11, 2024

(30) Foreign Application Priority Data
Oct. 13, 2023 (JP) 2023-177409

(51) Int. Cl. G06T 11/00

(52) U.S. Cl. CPC G06T 11/005; G06T 11/001; G06T 2210/41; G06T 2211/441

(57) ABSTRACT

A nuclear medicine diagnostic device includes a processing circuit. The processing circuit is configured to extract, in a first nuclear medicine image formed as a result of performing respiratory-gated reconstruction with respect to nuclear medicine data obtained by performing nuclear medicine scanning of a subject, a region in which body motion is occurring; and control a display in such a way that the region is displayed in an identifiable manner in the first nuclear medicine image.

### CROSS-REFERENCE TO RELATED APPLICATIONS

This application is based upon and claims the benefit of priority from Japanese Patent Application No. 2023-177409, filed on Oct. 13, 2023; the entire contents of which are incorporated herein by reference.

### FIELD

Embodiments described herein relate generally to a nuclear medicine diagnostic device and a data processing device.

### BACKGROUND

In a nuclear medicine diagnostic device, respiratory-gated mages are occasionally generated. As an example, with the aim of studying the specificity of the cumulation found in the chest region or the abdominal region, sometimes respiratory-gated images are generated along with non-respiratory-gated images.

However, when a respiratory-gated image is individually displayed in a display unit or when a respiratory-gated image and a non-respiratory-gated image are displayed merely side by side in the display unit, there are times when the knowledge gained by thoroughly examining the non respiratory-gated image cannot be efficiently reused, or when the areas affected by the body motion cannot be figured out from a broad perspective.

For example, in an image used in the interpretation of radiogram, when there is no clarity about the portion that is being affected by the body motion; if the task of studying the effect of the body motion is carried out while referring to an image not used in the interpretation of radiogram, the interpretation of radiogram is likely to require unnecessary man-hours.

### BRIEF DESCRIPTION OF THE DRAWINGS

FIG. 1 is a diagram illustrating a configuration of a PET apparatus 100 representing a nuclear medicine diagnostic device according to embodiments;

FIG. 2 is an exemplary flowchart for explaining the flow of operations performed in the nuclear medicine diagnostic device according to a first embodiment;

FIG. 3 is a flowchart for explaining, in more detail, the operation performed at Step S200 illustrated in FIG. 2;

FIGS. 4 and 5 are diagrams for explaining the operations performed in the nuclear medicine diagnostic device according to the first embodiment;

FIG. 6 is a diagram illustrating a non-respiratory-gated image as an example of an image according to a comparison example;

FIG. 7 is a diagram illustrating an exemplary image displayed in the nuclear medicine diagnostic device according to the first embodiment;

FIG. 8 is a diagram illustrating an exemplary image displayed in the nuclear medicine diagnostic device according to a modification example of the first embodiment;

FIG. 9 is a flowchart for explaining the flow of operations performed in the nuclear medicine diagnostic device according to a second embodiment; and

FIGS. 10 and 11 are diagrams for explaining the operations performed in the nuclear medicine diagnostic device according to a third embodiment.

### DETAILED DESCRIPTION

A nuclear medicine diagnostic device includes a processing circuit. The processing circuit extracts, in a first nuclear medicine image formed as a result of performing respiratory-gated reconstruction with respect to nuclear medicine data obtained by performing nuclear medicine scanning of a subject, a region in which body motion is occurring; and controls a display in such a way that the region is displayed in an identifiable manner in the first nuclear medicine image.

### First Embodiment

Embodiments of a nuclear medicine diagnostic device and a data processing device are described below in detail with reference to the accompanying drawings.

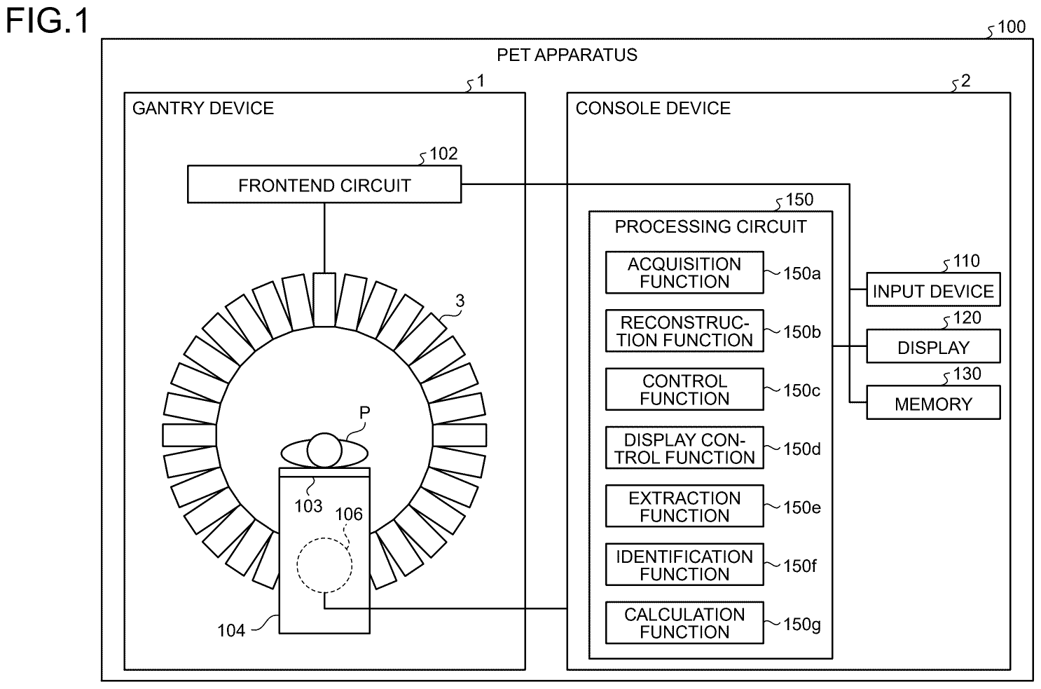

FIG. 1 is a diagram illustrating a configuration of a PET apparatus 100 representing a nuclear medicine diagnostic device according to the embodiments. As illustrated in FIG. 1, the PET apparatus 100 according to the embodiments includes a gantry device 1 and a console device 2. The gantry device 1 includes detectors 3, a frontend circuit 102, a couchtop 103, a couch 104, and a couch driving unit 106.

The detectors 3 detect radioactivity by detecting the scintillation light (fluorescence) representing the light re-emitted at the time of retransition to the ground state of a material that had switched to the excited state due to the interaction of gamma rays, which are generated when the positrons emitted from a medicinal substance administered and cumulated in a subject cause annihilation with the electrons of the surrounding body tissue, with a luminescent material.

Moreover, in the embodiments, the detectors 3 are capable of detecting the Cerenkov light too. The detectors 3 detect the energy information of the gamma radiation that is generated when the positrons emitted from a medicinal substance, which is administered and cumulated in a subject, cause annihilation with the electrons of the surrounding body tissue. Herein, a plurality of detectors 3 is arranged to surround a subject P in a ring-like manner, and each detector 3 is made of, for example, a plurality of detector blocks.

Typically, each detector 3 is made of a scintillator crystal and a photodetection surface formed with a photodetection element.

Regarding the material of the scintillator crystal, for example, it is possible to use a material suitable for generating the Cerenkov light. For example, it is possible to use bismuth germanium oxide (BGO) or a lead compound such as lead glass (SiO₂+PbO), or lead fluoride (PbF₂), or PWO (lead tungstate (PbWO₄)). As another example, it is possible to use a scintillator crystal such as lutetium yttrium oxyorthosilicate (LYSO), or lutetium oxyorthosilicate (LSO), or lutetium gadolinium oxyorthosilicate (LGSO), or bismuth germanium oxide (BGO). The photodetection element constituting a photodetection surface is made of, for example, a plurality of pixels each of which is configured with a single photon avalanche diode (SPAD). Meanwhile, the configuration of the detectors 3 is not limited to the configuration explained above. Alternatively, as an example, as the photodetection element, silicon photomultiplier (SiPM) or a photomultiplier tube can be used.

A scintillator crystal can be a monolithic crystal, and the photodetection surface made of a photodetection element can be placed on, for example, the six faces of a scintillator crystal.

In the gantry device 1, the frontend circuit 102 generates count information from the output signals of the detector 3; and the count information is stored in a memory 130 of the console device 2. Meanwhile, each detector 3 is partitioned into a plurality of blocks and includes the frontend circuit 102.

The frontend circuit 102 converts the output signals of the corresponding detector 3 into digital data and generates count information. The count information contains the detection positions, the energy values, and the detection time of annihilation gamma rays. For example, the frontend circuit 102 identifies such a plurality of photodetection elements which converted the scintillation light into electrical signals at the same timing. Then, the frontend circuit 102 identifies the scintillator number (P) indicating the position of the scintillator on which the annihilation gamma rays have fallen. Regarding the method for identifying the position of the scintillator on which the annihilation gamma rays have fallen, the identification can be done by performing gravity center processing based on the position of each photodetection element and the intensity of electrical signals. Moreover, when the scintillators have a corresponding size to the element size of the photodetection elements, for example, the scintillator corresponding to that photodetection element from which the maximum output was obtained is assumed to be the scintillator position on which the annihilation gamma rays have fallen; and the final identification is done by also taking into account the inter-scintillator scattering.

Moreover, the frontend circuit 102 performs integral calculation of the intensity of the electrical signals output from each photodetection element or measures the period of time for which the electrical signal intensity exceeds a threshold value (i.e., measures the time over threshold), and identifies the energy value (E) of the annihilation gamma rays incident on the detector 3. Furthermore, the frontend circuit 102 identifies the detection time (T) for which the corresponding detector 3 detects the scintillation light attributed to the annihilation gamma rays. Meanwhile, the detection time (T) either can be an absolute timing or can be the elapsed time since the start of imaging. In this way, the frontend circuit 102 generates count information containing the scintillator number (P), the energy value (E), and the detection period (T).

The frontend circuit 102 is implemented using, for example, a central processing unit (CPU), or a graphical processing unit (GPU), or a circuit such as an application specific integrated circuit (ASIC) or a programmable logic device (for example, a simple programmable logic device (SPLD), a complex programmable logic device (CPLD), or a field programmable gate array (FPGA)). Herein, the frontend circuit 102 represents an example of a frontend unit.

The couchtop 103 is a bed on which the subject P is asked to lie down; and is placed on top of the couch 104. The couch driving unit 106 moves the couchtop 103 under the control performed by a control function 150c of a processing circuit 150. For example, the couch driving unit 106 moves the couchtop 103 so that the subject P is moved inside the imaging bore of the gantry device 1.

The console device 2 receives the operations performed by the operator with respect to the PET apparatus 100, and accordingly controls the imaging of PET images as well as reconstructs PET images using the count information collected by the gantry device 1. As illustrated in FIG. 1, the console device 2 includes the processing circuit 150, an input device 110, a display 120, and the memory 130. The constituent elements of the console device 2 are connected to each other by a bus. Regarding the details of the processing circuit 150, the explanation is given later.

The input device 110 is a mouse or a keyboard used by the operator of the PET apparatus 100 for inputting various instructions and various settings; and transfers the input instructions and the input settings to the processing circuit 150. For example, the input device 110 is used in inputting an imaging start instruction.

The display 120 is a monitor watched by the operator; and, under the control performed by the processing circuit 150, is used to display the respiratory waveform of the subject, to display PET images, and to display a graphical user interface (GUI) meant for receiving various instructions and various settings from the operator.

The memory 130 is used to store a variety of data useful in the PET apparatus 100. The memory 130 is configured using, for example, a memory. As an example, the memory is configured using a semiconductor memory device such as a random access memory (RAM) or a flash memory, or using a hard disk, or using an optical disk. The memory 130 is used to store the following: count information in which the scintillator numbers (P), the energy values (E), and the detection time (T) are held in a corresponding manner; coincidence count information in which the sets of count information are held in a corresponding manner to coincidence numbers representing the serial numbers of the sets of coincidence count information; projection data obtained as a result of collecting the coincidence count information; and reconstructed PET images.

The processing circuit 150 includes an acquisition function 150a, a reconstruction function 150b, the control function 150c, a display control function 150d, an extraction function 150e, an identification function 150f, and a calculation function 150g. Regarding the extraction function 150e, the identification function 150f, and the calculation function 150g; the detailed explanation is given later.

The processing functions implemented in the acquisition function 150a, the reconstruction function 150b, the control function 150c, the display control function 150d, the extraction function 150e, the identification function 150f, and the calculation function 150g are stored as computer-executable programs in the memory 130. The processing circuit 150 is a processor that reads the computer programs from the memory 130 and executes them to implement the corresponding functions. In other words, upon reading the computer programs, the processing circuit 150 gets equipped with the functions illustrated in the processing circuit 150 in FIG. 1.

With reference to FIG. 1, the explanation is given about the case in which the acquisition function 150a, the reconstruction function 150b, the control function 150c, the display control function 150d, the extraction function 150e, the identification function 150f, and the calculation function 150g are implemented in the single processing circuit 150. However, alternatively, a plurality of individual processors can be combined to constitute the processing circuit 150, and each processor can execute computer programs to implement functions. In other words, the abovementioned functions can be configured as computer programs, and a single processing circuit 150 can execute the computer programs. As another example, specific functions can be installed in a program execution circuit that is a dedicated and independent circuit.

In the explanation given above, the term “processor” implies, for example, a central processing unit (CPU), or a graphical processing unit (GPU), or a circuit such as an application specific integrated circuit (ASIC) or a programmable logic device (for example, a simple programmable logic device (SPLD), a complex programmable logic device (CPLD), or a field programmable gate array (FPGA)). The processor reads the computer programs stored in the memory 130, and executes them to implement the functions.

Meanwhile, with reference to FIG. 1, the acquisition function 150a, the reconstruction function 150b, the control function 150c, the display control function 150d, the extraction function 150e, the identification function 150f, and the calculation function 150g respectively represent an example of an obtaining unit, a reconstructing unit, a display control unit, an extracting unit, an identifying unit, and a calculating unit.

In the processing circuit 150, the acquisition function 150a obtains data from the frontend circuit 102. Then, in the processing circuit 150, based on the data obtained by the frontend circuit 102, the reconstruction function 150b reconstructs PET images, and generates images.

The control function 150c of the processing circuit 150 controls the gantry device 1 and the console device 2, so as to perform overall control of the PET apparatus 100. For example, the control function 150c of the processing circuit 150 controls the imaging performed in the PET apparatus 100. Moreover, the control function 150c of the processing circuit 105 controls the couch driving unit 106.

The display control function 150d of the processing circuit 150 displays PET images and other data in the display 120.

Given below is the explanation about the background related to the embodiments.

In a nuclear medicine diagnostic device, respiratory-gated images are occasionally generated. As an example, with the aim of studying the specificity of the cumulation found in the chest region or the abdominal region, sometimes respiratory-gated images are generated along with non-respiratory-gated images.

However, when a respiratory-gated image is individually displayed in a display unit or when a respiratory-gated image and a non respiratory-gated image are displayed merely side by side in the display unit, there are times when the knowledge gained by thoroughly examining the non respiratory-gated image cannot be efficiently reused, or when the areas affected by the body motion cannot be figured out from a broad perspective. Hence, sometimes the efficiency of the interpretation of radiogram is poor.

For example, regarding an area not affected by the body motion, the interpretation of radiogram can be done based on the knowledge evaluated in advance in a non-gated image. However, in the image used in the interpretation of radiogram, when there is no clarity about the portion that is being affected by the body motion, it results in carrying out the task of thoroughly examining the effect of the body motion while referring to an image not used in the interpretation of radiogram. Hence, the interpretation of radiogram is likely to require unnecessary man-hours.

Moreover, in a non-gated image, at the time of carrying out the task of finding the cumulation that was not visible because of the blurring attributed to the body motion, the efficiency is good if the search is focused in the areas in which the body motion is conspicuous. However, when a respiratory-gated image is individually displayed in the display unit or when a respiratory-gated image and a non respiratory-gated image are displayed merely side by side in the display unit, the areas having the body motion cannot be displayed from a broad perspective. Hence, for example, regardless of whether the entire liver of the patient moves due to the respiratory movement or whether only the upper part of the liver moves, the radiogram interpreter has to examine all the way down to the lower part of the liver.

The embodiments are based on the background explained above. A nuclear medicine diagnostic device according to the embodiments includes an extracting unit and a display control unit. The extracting unit extracts, in a first nuclear medicine image formed as a result of performing respiratory-gated reconstruction with respect to nuclear medicine data obtained by performing nuclear medicine scanning of a subject, a region in which body motion is occurring. The display control unit controls a display in such a way that the region is displayed in an identifiable manner in the first nuclear medicine image.

Moreover, a data processing device according to the embodiments includes an extracting unit and a display control unit. The extracting unit extracts, in a first nuclear medicine image formed as a result of performing respiratory-gated reconstruction with respect to nuclear medicine data obtained by performing nuclear medicine scanning of a subject, a region in which body motion is occurring. The display control unit controls a display in such a way that the region is displayed in an identifiable manner in the first nuclear medicine image.

Firstly, at Step S100, the acquisition function 150a of the processing circuit 150 performs nuclear medicine scanning of the subject and obtains nuclear medicine data. Herein, nuclear medicine scanning implies scanning of the subject by administering a drug labeled with a radionuclide. Typically, nuclear medicine scanning implies PET scanning or SPECT scanning (SPECT stands for Single Photon Emission Computed Tomography). In the case of PET scanning, the acquisition function 150a of the processing circuit 150 performs PET scanning and obtains list-mode data as PET image data. In the case of SPECT scanning, the acquisition function 150a of the processing circuit 150 performs SPECT scanning of the subject and obtains SPECT image data.

At Step S100, the explanation is given about the case in which the data obtained by the acquisition function 150a of the processing circuit 150 is list-mode data prior to image reconstruction. However, the embodiments are not limited to that case. Alternatively, the data obtained by the acquisition function 150a of the processing circuit 150 can be image data, sinogram data, or raw data.

Subsequently, at Step S200, the reconstruction function 150b of the processing circuit 150 performs respiratory-gated reconstruction and generates nuclear medicine images having been subjected to respiratory-gated reconstruction. As an example, the reconstruction function 150b of the processing circuit 150 performs respiratory-gated reconstruction based on the PET image data representing the list-mode data obtained at Step S100; and generates PET images having been subjected to respiratory-gated reconstruction.

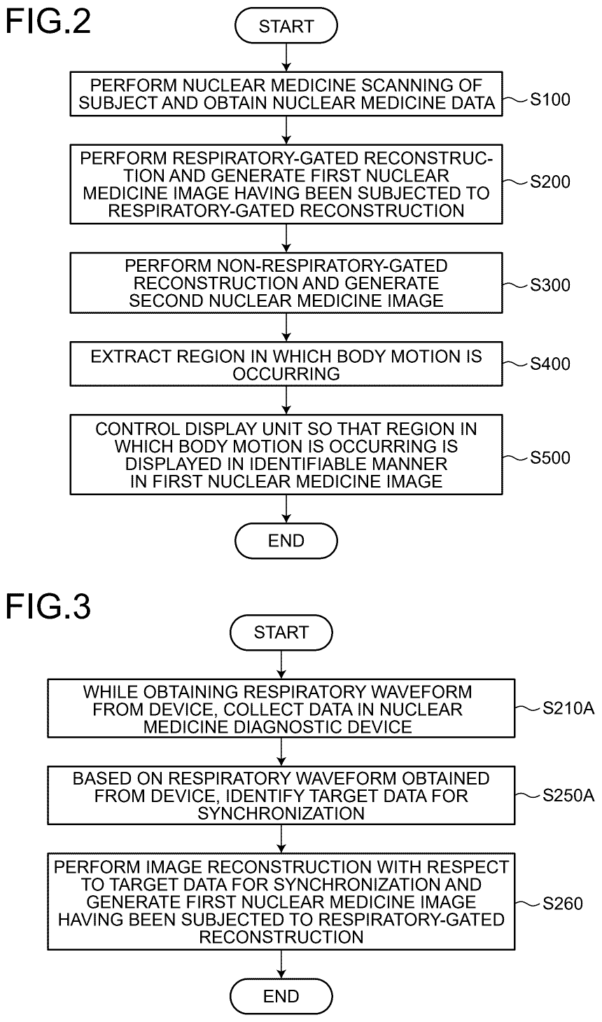

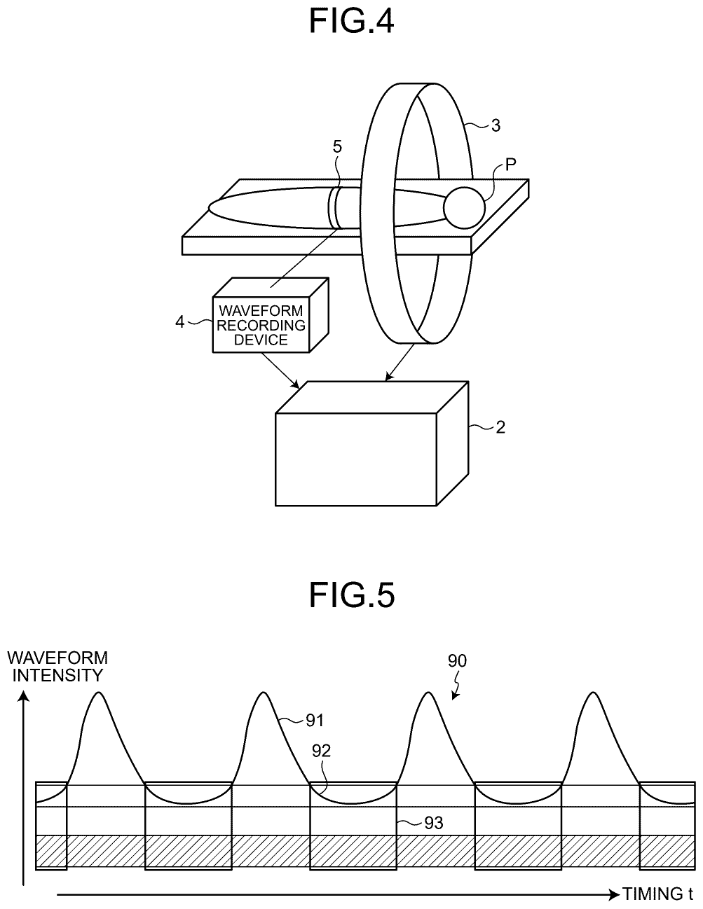

The details of the abovementioned operation are explained with reference to FIG. 3. FIG. 3 is a flowchart for explaining, in more detail, the operation performed at Step S200 illustrated in FIG. 2.

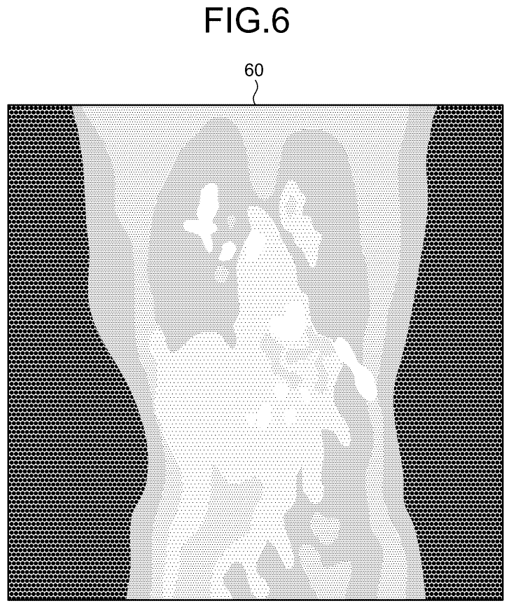

Firstly, at Step S210A, at the time of performing nuclear medicine scanning of the subject, while obtaining the respiratory waveform from a waveform recording device 4, the processing circuit 150 collects data from the nuclear medicine diagnostic device. As an example, as illustrated in FIG. 4, a pressure detection belt 5 is attached to the subject P. The waveform recording device 4 representing a respiration monitor for detecting the pressure on the pressure detection belt 5 detects the signal of the pressure detected by the pressure detection belt 5, and obtains waveform data of the respiratory movement of the subject P. In FIG. 5 is illustrated the outline of waveform data 90 obtained by the waveform recording device 4. By referring to the waveform data 90 obtained by the waveform recording device 4, it can be understood that there is significant variation in the respiratory movement during a time phase 91, and that there is only a small variation in the respiratory movement during a time phase 92. If the processing circuit 150 treats a time domain 93, in which it is believed to have only a small variation in the respiratory movement, as the target time domain for synchronization; it is believed that the effect of the respiratory movement on the nuclear medicine images can be held down.

The waveform recording device 4 sends the obtained waveform data of the respiratory movement of the subject P to the console device 2 of the PET apparatus 100. Usually, the operation at Step S210A is performed in a concurrent manner to the operation at Step S100.

Then, at Step S250A, based on the respiratory waveform obtained by the waveform recording device 4, the identification function of the processing circuit 150 identifies the target data for synchronization. As an example, as illustrated in FIG. 5, the identification function 150f of the processing circuit 150 identifies, as the time domain of the target data for synchronization, the time domain 93 having a stable waveform from the waveform data 90 obtained by the waveform recording device 4.

Subsequently, at Step S260, the reconstruction function 150b of the processing circuit 150 performs image reconstruction with respect to the target data for synchronization identified at Step S250A, and generates a first nuclear medicine image having been subjected to respiratory-gated reconstruction. As an example, the reconstruction function 150b of the processing circuit 150 selects, as the target for image reconstruction, the list-mode data related to the target data for synchronization identified at Step S250A; performs image reconstruction; and generates a PET image having been subjected to respiratory-gated reconstruction as the first nuclear medicine image. As another example, the reconstruction function 150b of the processing circuit 150 can increase the weight of the range of the target data for synchronization to be higher than the weight of the remaining range; can perform weighted image reconstruction; and can generate a PET image having been subjected to respiratory-gated reconstruction as the first nuclear medicine image. In this way, the reconstruction function 150b of the processing circuit 150 performs respiratory-gated reconstruction based on the waveform data 90 of the respiration of the subject and generates a first nuclear medicine image; and generates a PET image having been subjected to respiratory-gated reconstruction as the first nuclear medicine image.

Returning to the explanation with reference to FIG. 2, subsequently, the reconstruction function 150b of the processing circuit 150 performs non-respiratory-gated reconstruction based on the nuclear medicine data obtained at Step S100, and generates a second nuclear medicine image. Herein, non-respiratory-gated reconstruction implies performing reconstruction using the list-mode data of all time phases. That is, based on the nuclear medicine data obtained at Step S100, the reconstruction function 150b of the processing circuit 150 performs non-respiratory-gated reconstruction in which reconstruction is performed using the list-mode data of all time phases, and generates a second nuclear medicine image.

Then, at Step S400, the extraction function 150e of the processing circuit 150 extracts the region in which the body motion is occurring. As an example, in a nuclear medicine image formed as a result of performing respiratory-gated reconfiguration with respect to the nuclear medicine data that is obtained by performing nuclear medicine scanning of the subject, based on the difference between the first nuclear medicine image and the second nuclear medicine image, the extraction function 150e of the processing circuit 150 extracts the region in which the body motion is occurring. As an example, the region having such pixels for which the difference in the signal value between the first nuclear medicine image, which is formed when the reconstruction function 150b of the processing circuit 150 performs reconstruction in a predetermined respiratory time phase according to respiratory-gated reconstruction, and the second nuclear medicine image, which is formed when the reconstruction function 150b of the processing circuit 150 performs reconstruction in all time phases according to non-respiratory-gated reconstruction, is greater than a predetermined threshold value is extracted as the region in which the body motion is occurring.

Subsequently, at Step S500, the display control function 150d of the processing circuit 150 controls the display 120, which represents a display unit, in such a way that the region in which the body motion is occurring is displayed in an identifiable manner in the nuclear medicine image. As an example, the display control function 150d of the processing circuit 150 controls the display 120, which represents the display unit, in such a way that the region in which the body motion is occurring as extracted at Step S400 is displayed in an identifiable manner in the nuclear medicine image. As an example, the display control function 150d of the processing circuit 150 superimposes, on the nuclear medicine image generated at Step S200, the color display of the region in which the body motion is occurring.

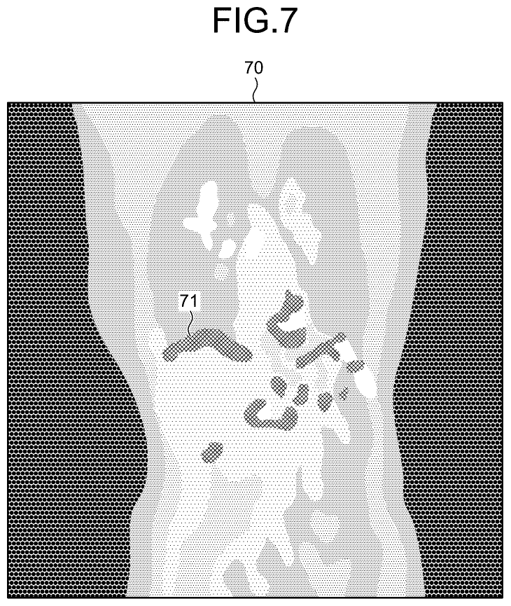

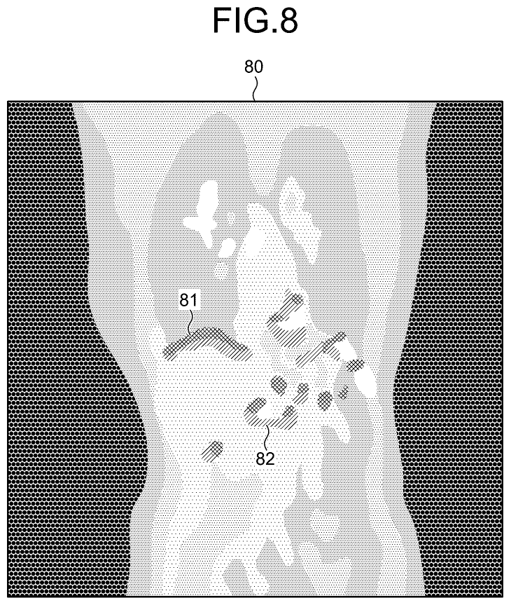

The abovementioned operation is explained below with reference to FIGS. 6 and 7. In FIG. 6, a second nuclear medicine image having been subjected to non-respiratory-gated reconstruction is displayed as a non-gated image 60. In FIG. 7 is illustrated a gated image 70 in which the color display of a region 71, in which the body motion is occurring, is superimposed on a first nuclear medicine image having been subjected to respiratory-gated reconstruction. Thus, at Step S500, for example, in the display 120 representing the display unit, the display control function 150d of the processing circuit 150 can superimpose the color display of the region 71, in which the body motion is occurring, on the gated image 70 representing the first nuclear medicine image generated at Step S200.

As explained above, in the first embodiment, the display control function 150d of the processing circuit 150 superimposes the color display of the region 71, in which the body motion is occurring, on the gated image 70 representing the first nuclear medicine image having been subjected to respiratory-gated reconstruction. As a result, in the gated image 70, the difference with the non-gated image 60 is made visible. Hence, for example, the user becomes able to use the knowledge gained by thoroughly examining the non-gated image 60 in advance, and perform radiogram interpretation with efficiency. As an example, regarding a region having no difference in the non-gated image 60 and the gated image 70, the user can perform radiogram interpretation using only the gated image 70 and without checking the non-gated image 60. As a result, the user becomes able to eliminate unnecessary efforts of doubly checking the images, thereby resulting in an enhancement in the radiogram interpretation efficiency.

As another effect, for example, if such a region in the non-gated image 60 in which no tumor was found is thoroughly examined in the gated image 70, there is a possibility of finding the cumulation that could not be found in the non-gated image 60 due to the blurring attributed to the body motion. In that case, after looking at the non-gated image 60, if the gated image 70 is checked while focusing on the region 71 in which the body motion is occurring, the user can find the cumulation. Since the region 71 in which the body motion is occurring is highlighted by means of the color display in the gated image 70, the user can perform the abovementioned task in an efficient manner.

### Modification Example of First Embodiment

In the first embodiment, the explanation is given about the case in which, at Step S500, when the region 71 in which the body motion is occurring is to be displayed in the display 120 representing the display unit in such a way that the region 71 is identifiable in the first nuclear medicine image, the display control function 150d of the processing circuit 150 displays particularly the region 71 in color. In a modification example of the first embodiment, the explanation is given about a case in which, at Step S500, the display control function 150d of the processing circuit 150 superimposes toned color display of the region 71 in which the body motion is occurring.

That is, in the modification example of the first embodiment, at Step S500, the display control function 150d of the processing circuit 150 varies the tone of the display according to the magnitude of the body motion. As an example, the display control function 150d of the processing circuit 150 varies the tone of the colors, which are displayed in the color display, according to the magnitude of the body motion.

More particularly, at Step S400, the calculation function 150g of the processing circuit 150 calculates, for each pixel, an estimated value of the magnitude of the body motion. As an example, based on the waveform data 90 obtained from the waveform recording device 4, the calculation function 150g of the processing circuit 150 calculates the estimated value of the magnitude of the body motion. As another example, based on the raw data obtained as the nuclear medicine data at Step S100, the calculation function 150g of the processing circuit 150 calculates the estimated value of the magnitude of the body motion. At still another example, based on the first nuclear medicine image generated at Step S200, the calculation function 150g of the processing circuit 150 calculates the estimated value of the magnitude of the body motion. For example, based on the difference between the first nuclear medicine image generated at Step S200 and the second nuclear medicine image generated at Step S300, the calculation function 150g of the processing circuit 150 calculates the estimated value of the magnitude of the body motion. As still another example, based on a non-respiratory-gated image and a gated image present in the sinogram space, the calculation function 150g of the processing circuit 150 can calculate the estimated value of the magnitude of the body motion.

Then, according to the calculated magnitude of the body motion, the display control function 150d of the processing circuit 150 varies the tone of the colors to be displayed in the color display. As an example, the display control function 150d of the processing circuit 150 controls the display 120, which represents the display unit, in such a way that darker colors are assigned to the pixels at which the estimated magnitude of the body motion is greater.

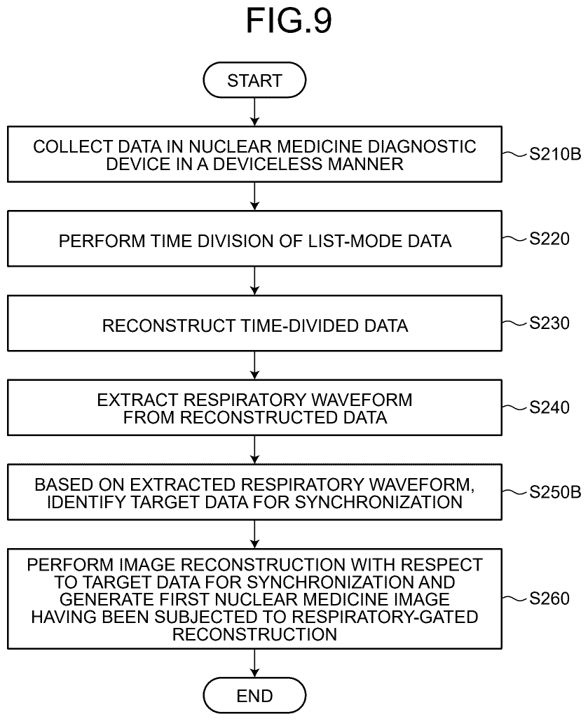

In FIG. 8 is illustrated an example of the abovementioned operation. In the modification example of the first embodiment, the display control function 150d of the processing circuit 150 superimposes the color display of regions 81 and 82, in which the body motion is occurring, on a gated image 80 representing the first nuclear medicine image having been subjected to respiratory-gated reconstruction. The region 81 is estimated to have greater magnitude of the body motion as compared to the region 82. Accordingly, the display control function 150d of the processing circuit 150 superimposes, on the gated image 80, the color display of the region 81 in darker colors than the color display of the region 82. As a result, in the area in which the body motion has greater magnitude, the user becomes able to intuitively figure out the magnitude of the body motion, and to achieve enhancement in the efficiency of radiogram interpretation.

As explained above, in the modification example of the first embodiment, according to the calculated magnitude of the body motion, the display control function 150d of the processing circuit 150 varies the tone of the colors to be displayed in the color display. As a result, the user becomes able to intuitively figure out the magnitude of the body motion, and to achieve enhancement in the efficiency of radiogram interpretation.

### Second Embodiment

In the first embodiment, the explanation is given about the case in which the waveform recording device 4 obtains the respiratory waveform of the user and, at Step S200, the reconstruction function 150b of the processing circuit 150 generates a first nuclear medicine image representing a respiratory-gated image. In a second embodiment, the explanation is given about a case in which the reconstruction function 150b of the processing circuit 150 generates a first nuclear medicine image, which represents a respiratory-gated image, using, what is called, data-driven respiratory-gating.

Herein, data-driven respiratory-gating implies: estimation of the respiratory time phase in a deviceless manner without using a device for obtaining the respiratory waveform and based on the actual data obtained by the nuclear medicine diagnostic device; and generation of the gated image 70 by the reconstruction function 150b of the processing circuit 150 using the estimated respiratory time phase. In other words, at Step S200, the reconstruction function 150b of the processing circuit 150 performs respiratory-gating reconstruction based on the nuclear medicine data obtained by performing nuclear medicine scanning of the subject, and generates the gated image 70 as a nuclear medicine image. As an example, the reconstruction function 150b of the processing circuit 150 identifies the target data range for gating that is to be subjected to respiratory-gated reconstruction based on the obtained nuclear medicine data; performs respiratory-gated reconstruction based on the identified data range; and generates the gated image 70.

In the second embodiment, other than the operation performed at Step S200, the operations illustrated in FIG. 2 are identical to the first embodiment. Hence, their explanation is not given again.

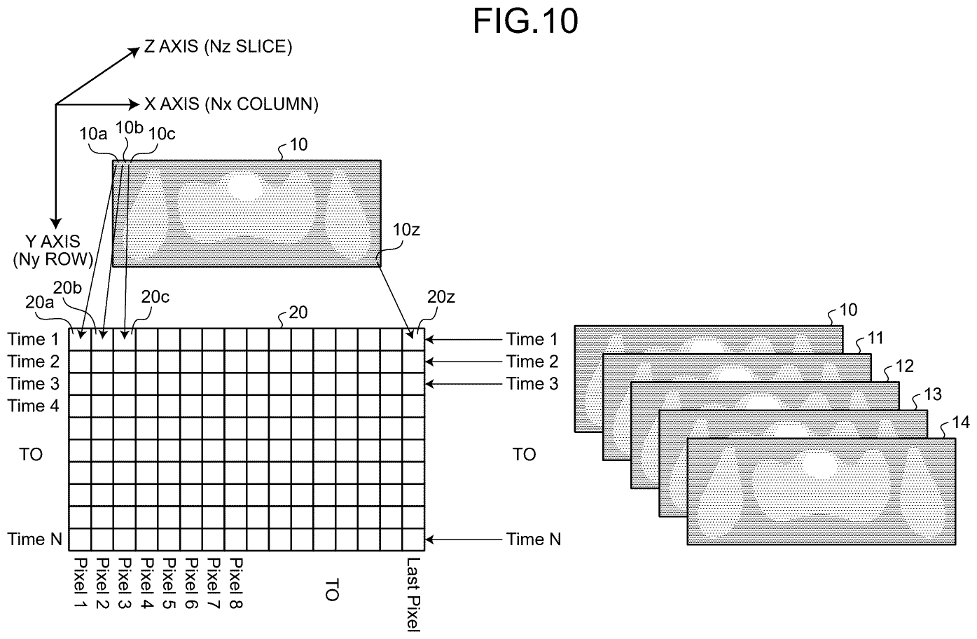

FIG. 9 is a flowchart for explaining the flow of the operation performed at Step S200 illustrated in FIG. 2. In the second embodiment, instead of performing the operations from Step S210A to Step S260 illustrated in FIG. 3, the processing circuit 150 performs operations from Step S210B to Step S260 illustrated in FIG. 9, and thus carried out the operation at Step S200.

Firstly, at Step S210B, the PET apparatus 100 representing a nuclear medicine diagnostic device collects nuclear medicine data in a deviceless manner. Herein, collecting data in a deviceless manner implies, for example, collecting data of a nuclear medicine diagnostic device without using a device for recording the respiratory waveform of the subject P, such as without using the waveform recording device 4. Then, the acquisition function 150a of the processing circuit 150 obtains the collected nuclear medicine data via the frontend circuit 102. The nuclear medicine data obtained by the processing circuit 150 via the frontend circuit 102 is, for example, the list-mode data.

Then, at Step S220, the reconstruction function 150b of the processing circuit 150 performs time division of the nuclear medicine data collected at Step S210B, and generates time-divided nuclear medicine data. As an example, the reconstruction function 150b of the processing circuit 150 performs time division of the list-mode nuclear medicine data, which is collected at Step S210B, into small time units of, for example, 0.5 seconds; and generates a plurality of sets of time-divided nuclear medicine data.

Then, at Step S230, the reconstruction function 150b of the processing circuit 150 performs the reconstruction operation with respect to each set of time-divided nuclear medicine data generated at Step S220, and generates a post-reconstruction time-divided nuclear medicine image.

Subsequently, at Step S240, the extraction function 150e of the processing circuit 150 extracts the respiratory waveform from the time-divided nuclear medicine image generated at Step S230. As an example, the extraction function 150e of the processing circuit 150 calculates the average value of the pixel values of the time-divided nuclear medicine image generated at Step S230, and extracts the waveform data 90 as the data corresponding to the respiratory waveform.

Then, at Step S250B, based on the respiratory waveform extracted at Step S240, the identification function 150f of the processing circuit 150 identifies the target data for gating. As an example, the extraction function 150e of the processing circuit 150 analyzes the reciprocal change occurring in the sets of time-divided nuclear medicine data generated at Step S230; estimates the respiratory phase; and identifies the target data for gating based on the estimated respiratory phase. As an example, as illustrated in FIG. 5, based on the waveform data 90 extracted at Step S240, the identification function 150f of the processing circuit 150 identifies the time domain 93, in which there is less variation in the waveform data 90, as the time domain of the target data for gating.

Subsequently, at Step S260, the reconstruction function 150b of the processing circuit 150 performs image reconstruction with respect to the target data for gating as identified at Step S250B, and generates a first nuclear medicine image having been subjected to respiration-gating reconstruction.

In this way, in the second embodiment, first nuclear medicine image data having been subjected to respiratory-gated reconstruction is generated and then the operations identical to the first embodiment are performed as illustrated in FIG. 2. More particularly, at Step S300, the reconstruction function 150b of the processing circuit 150 performs non-respiratory-gated reconstruction based on the nuclear medicine data obtained at Step S100 and generates a second nuclear medicine image.

Then, at Step S400, the extraction function 150e of the processing circuit 150 extracts the region 71 in which the body motion is occurring. As an example, in the nuclear medicine image formed as a result of performing respiratory-gated reconstruction with respect to the nuclear medicine data that is obtained by performing nuclear medicine scanning of the subject, the extraction function 150e of the processing circuit 150 extracts, based on the difference between the first nuclear medicine image obtained based on the operations from Step S210B to Step S260 illustrated in FIG. 9 and the second nuclear medicine image obtained based on the operation at Step S300, the region in which the body motion is occurring. As an example, as the region in which the body motion is occurring, the reconstruction function 150b of the processing circuit 150 extracts the region having such pixels for which the difference in the signal value between the first nuclear medicine image, which is formed as a result of performing reconstruction in a predetermined respiratory time phase according to respiratory-gated reconstruction, and the second nuclear medicine image, which is formed as a result of performing reconstruction in all time phases according to non-respiratory-gated reconstruction, is greater than a predetermined threshold value.

Meanwhile, the embodiments are not limited to the example given above, and it is alternatively possible to omit the operation at Step S300. That is, at Step S400, the extraction function 150e of the processing circuit 150 can extract the region 71, in which the body motion is occurring, without using the second nuclear medicine image obtained as a result of performing non-respiratory-gated reconstruction, but using only the first nuclear medicine image generated at Step S200.

As an example, the extraction function 150e of the processing circuit 150 can use a feature extraction technology such as data compression and, at Step S400, can extract the region 71 in which the body motion is occurring. As an example, the extraction function 150e of the processing circuit 150 can use principal component analysis (PCA) as the feature extraction technology, and extract the region 71 in which the body motion is occurring. As an embodiment in which, at Step S400, principal component analysis is performed as the feature extraction technology for extracting the region 71 in which the body motion is occurring; a third embodiment is described later in detail.

As another example, the extraction function 150e of the processing circuit 150 can extract the region 71, in which the body motion is occurring, from nuclear medicine data obtained by performing nuclear medicine scanning of the subject using a neural network. As an example, the extraction function 150e of the processing circuit 150 can use a neural network and extract the region 71, in which the body motion is occurring, from the first nuclear medicine image generated at Step S200 and from the time-divided data generated at Step S220. As an example, the extraction function 150e of the processing circuit 150 can implement a semantic segmentation technology such as U-net and extract the region 71, in which the body motion is occurring, according to a neural network.

Regarding the data format of the data used in the feature extraction technology or the data input to the neural network, apart from using the image data such as the first nuclear medicine image, or using the time-divided data generated at Step S220, or using the list-mode data; it is also possible to use raw data, or intermediate data such as sinogram data, or compressed data having been subjected to data compression.

As an example of the compressed data that has been subjected to data compression in the case in which the region 71, in which the body motion is occurring, is extracted using a neural network; it is possible to cite the compressed data obtained as a result of performing data compression according to an autoencoder or a variable autoencoder (VAE). In an autoencoder, a neural network is trained in such a way that the data of the output layer that is output from the input layer in a form and via the intermediate layer is same as the data of the input layer. As a result, the processing circuit 150 becomes able to obtain, from the intermediate layer, the compressed data that holds the identical information as the input layer and that has a compressed dimensionality. The processing circuit 150 inputs the compressed data, which is obtained using an autoencoder or a variable autoencoder, to a neural network such as U-net, and extracts the region 71 in which the body motion is occurring.

At Step S500, the display control function 150d of the processing circuit 150 displays the region 71, in which the body motion is occurring, in the display unit represented by the display 120 in such a way that the region 71 is displayed in an identifiable manner in the first nuclear medicine image.

Meanwhile, in an identical manner to the operation performed at Step S400, regarding the analysis operation performed at Steps S240 and S250B too, instead of performing the operation at Steps S240 and S250B with respect to the image, the processing circuit 150 can perform the analysis operation with respect to intermediate data such as the raw data or the sinogram data and can extract the respiratory waveform or identify the target data for gating. Moreover, regarding the analysis operation performed at Steps S240 and S250B, the processing circuit 150 can use a special feature extraction technology such as data compression.

Moreover, the embodiments are not limited to the examples explained above. Thus, the second embodiment can be combined with, for example, the modification example of the first embodiment. As an example, based on the analysis result obtained at Steps S240 and S250B, the display control function 150d of the processing circuit 150 can vary the tone of the colors displayed in the color display of the region of the body motion. As an example, based on the fluctuation in the signal value of the time-divided data obtained from the nuclear medicine data that is obtained by performing nuclear medicine scanning of the subject, the display control function 150d of the processing circuit 150 can extract the region 71 in which the body motion is occurring; and, at Step S500, can vary the tone of the colors to be displayed in the color display in the display 120 representing the display unit. As an example, the display control function 150d of the processing circuit 150 can vary the assignment of the colors in such a way that, greater the fluctuation in the signal value of the time-divided data calculated at Step S240 or Step S250B, the darker are the colors displayed at Step S500.

As explained above, in the second embodiment, the PET apparatus 100 performs, what is called, data-driven respiratory-gated reconstruction and performs respiratory-gated reconstruction in a deviceless manner. As a result, respiratory-gated reconstruction can be performed without having to use the waveform recording device 4.

### Third Embodiment

In the first embodiment, the explanation is given about the case in which, at Step S400 at which the region 71 is extracted as the region in which the body motion is occurring, the extraction function 150e of the processing circuit 150 extracts the region 71 based on the difference between the non-gated image 60 and the gated image 70. In a third embodiment, the explanation is given about the case in which, when performing data-driven respiratory reconstruction and performing respiratory-gated reconstruction in a deviceless manner in an identical manner to the second embodiment, principal component analysis (PCA) is performed and the region 71 is extracted at Step S400 as the region in which the body motion is occurring. That is, at Step S400, the extraction function 150e of the processing circuit 150 extracts the region 71, in which the body motion is occurring, by performing principal component analysis.

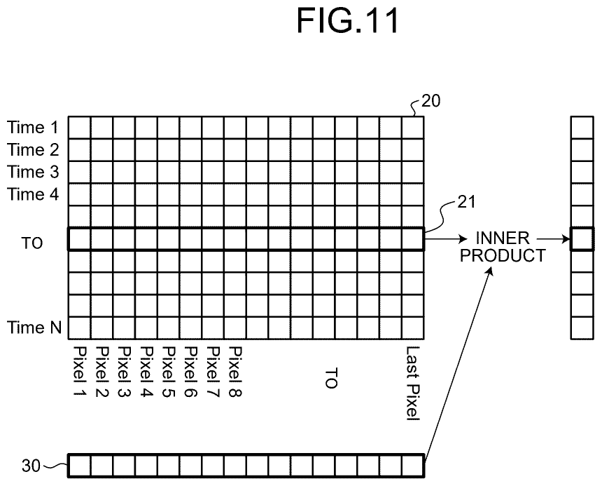

In FIGS. 10 and 11 is illustrated the operation of principal component analysis.

In the third embodiment, at Step S400 illustrated in FIG. 2, the extraction function 150e of the processing circuit 150 extracts the region 71, in which the body motion is occurring, by performing principal component analysis. Herein, the extraction function 150e of the processing circuit 150 performs principal component analysis using the nuclear medicine image data at each timing. For example, as illustrated in FIG. 10, the extraction function 150e of the processing circuit 150 performs principal component analysis using the following data: nuclear medicine image data 10 at timing t=1; nuclear medicine image data 11 at timing t=2; nuclear medicine image data 12 at timing t=3; nuclear medicine image data 13 at timing t=4; . . . ; and nuclear medicine image data 14 at timing t=N. The nuclear medicine image data at each timing represents three-dimensional matrix data having the size (Nₓ, N_{y}×N_{z}) and containing Nₓ number of sets of data, N_{y} number of sets of data, and N_{z} number of sets of data in the column direction, the row direction, and the slice direction, respectively. In order to perform principal component analysis, the processing circuit 150 converts the nuclear medicine image data at each timing into one-dimensional data having the size Nₓ×N_{y}×N_{z}. In FIG. 10, the nuclear medicine image data 10 represents the three-dimensional data at the timing t=1; and the extraction function 150e of the processing circuit 150 converts data points 10a, 10b, 10c, and 10z in the nuclear medicine image data 10, which is the three-dimensional data, into data points 20a, 20b, 20c, and 20z in one-dimensional data. Moreover, the extraction function 150e of the processing circuit 150 converts the sets of three-dimensional data representing the nuclear medicine image data 11 at the timing t=2, the nuclear medicine image data 12 at the timing t=3, the nuclear medicine image data 13 at the timing t=4, . . . , and the nuclear medicine image data 14 at the timing t=N into sets of one-dimensional data; and, from all sets of data, generates two-dimensional data 20 having the size (N, Nₓ, N_{y}, N_{z}). Then, the extraction function 150e of the processing circuit 150 performs principal component analysis with respect to the two-dimensional data 20.

As illustrated in FIG. 11, the extraction function 150e of the processing circuit 150 performs principal component analysis with respect to the two-dimensional data 20, and calculates a factor loading value 30 of the first principal component. Herein, the factor loading value 30 of the first principal component represents vector data of a length M=Nₓ×N_{y}×Nₓ having the value of the scalar quantity on a pixel-by-pixel basis. The vector data indicates which pixels value at which positions lead to a significant fluctuation in the time direction when retrieved.

Based on the factor loading value 30 of the principal component as obtained by performing principal component analysis, the extraction function 150e of the processing circuit 150 extracts the region 71 in which the body motion is occurring. The pixels at which the factor loading value 30 of the first principal component is large correspond to the pixels at which there is significant fluctuation in the time direction. Hence, at such pixels, it is possible to think that the body motion is highly likely to be occurring. The extraction function 150e of the processing circuit 150 extracts, as the region 71 in which the body motion is occurring, the region of such pixels at which the factor loading value 30 of the principal component obtained due to principal component analysis is high.

Meanwhile, the factor loading value 30 not only enables identification of the positions of the pixels at which there is fluctuation in the time direction but also indicates the magnitude of the fluctuation. Hence, based on the factor loading value 30, the display control function 150d of the processing circuit 150 can decide on the tone to be displayed in the display unit. As an example, based on the factor loading value 30, the display control function 150d of the processing circuit 150 decides on the tone of the region 71, in which the body motion is occurring, to be displayed in the display unit.

In the third embodiment, the explanation is given about the case in which the extraction function 150e of the processing circuit 150 performs principal component analysis with respect to the data in the image format and extracts the region 71 in which the body motion is occurring. However, the third embodiment is not limited to that case. Alternatively, the processing circuit 150 can perform principal component analysis with respect to intermediate data such as the raw data, the feature vectors, and the sinograms, or can convert such data into the data having the image format and then perform principal component analysis.

As explained above, in the third embodiment, the processing circuit 150 performs principal component analysis and automatically extracts the region 71 in which the body motion is occurring. That enables achieving enhancement in the accuracy of detection of the body motion, and achieving further enhancement in the efficiency of the user in the interpretation of radiogram.

According to at least one embodiment described above, it becomes possible to enable the user to perform the interpretation of radiogram with more efficiency.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A nuclear medicine diagnostic device comprising a processing circuit configured to
extract, in a first nuclear medicine image formed as a result of performing respiratory-gated reconstruction with respect to nuclear medicine data obtained by performing nuclear medicine scanning of a subject, a region in which body motion is occurring, and
control a display in such a way that the region is displayed in an identifiable manner in the first nuclear medicine image.

2. The nuclear medicine diagnostic device according to claim 1, wherein the processing circuit is configured to superimpose color display of the region on the first nuclear medicine image.

3. The nuclear medicine diagnostic device according to claim 2, wherein, according to magnitude of the body motion, the processing circuit is configured to vary tone of colors displayed in the color display.

4. The nuclear medicine diagnostic device according to claim 1, wherein the processing circuit is configured to
perform the respiratory-gated reconstruction further based on waveform data of respiration of the subject to generate the first nuclear medicine image,
perform non-respiratory-gated reconstruction based on the nuclear medicine data to generate a second nuclear medicine image, and
extract the region based on difference between the first nuclear medicine image and the second nuclear medicine image.

5. The nuclear medicine diagnostic device according to claim 1, wherein the processing circuit is configured to
perform the respiratory-gated reconstruction further based on the nuclear medicine data to generate the first nuclear medicine image, and
identify, based on the obtained nuclear medicine data, target data range for gating to be subjected to the respiratory-gated reconstruction, and perform the respiratory-gated reconstruction based on the identified data range.

6. The nuclear medicine diagnostic device according to claim 5, wherein the processing circuit is configured to
perform time division of the nuclear medicine data to generate sets of time-divided nuclear medicine data,
perform reconstruction of each of the generated sets of time-divided nuclear medicine data to generate a post-reconstruction time-divided nuclear medicine image,
extract a respiratory waveform from the generated time-divided nuclear medicine image, and
identify the data range from the extracted respiratory waveform.

7. The nuclear medicine diagnostic device according to claim 1, wherein the processing circuit is configured to extract the region from the nuclear medicine data using a neural network.

8. The nuclear medicine diagnostic device according to claim 1, wherein the processing circuit is configured to extract the region based on amount of fluctuation in signal value of time-divided data obtained from the nuclear medicine data.

9. The nuclear medicine diagnostic device according to claim 1, wherein the processing circuit is configured to extract the region by performing principal component analysis.

10. The nuclear medicine diagnostic device according to claim 9, wherein the processing circuit is configured to extract the region based on a factor loading value of a principal component obtained by performing the principal component analysis.

11. A data processing device comprising a processing circuit configured to:
in a nuclear medicine image formed as a result of performing respiratory-gated reconstruction with respect nuclear medicine data obtained by performing nuclear medicine scanning of a subject, extract a region in which body motion is occurring, and
control a display in such a way that the region is displayed in an identifiable manner in the nuclear medicine image.
